(19) United States
(12) Patent Application Publication
(10) Pub. No.: US 2002/0001694 A1
(43) Pub. Date: Jan. 3, 2002

(54) Foam molded part, method and device for producing a foam molded part for an upholstery element

(76) Inventor: Harmann Wetzel, Memmingen (DE)

Correspondence Address: McGLEW AND TUTTLE, P.C., SCARBOROUGH STATION, SCARBOROUGH, NY, 10510-0827, US

(21) Appl. No.: 09/875,124

(22) Filed: Jun. 6, 2001

(30) Foreign Application Priority Data
Jun. 7, 2000 (DE) 100 27 793.4
Aug. 4, 2000 (DE) 100 38 830.2

(51) Int. Cl. B32B 3/10; B29C 44/02; B29C 44/12

(52) U.S. Cl. 428/131; 428/156; 264/51; 425/468; 425/4 R; 425/436 R; 264/46.4; 425/116

(57) ABSTRACT

This invention relates to a foam molded part made of a soft foam-like material, in particular for an upholstery element of an automotive seat. The foam molded part has at least two spatially separate zones which are designed in one piece, each preferably having different material properties.

In addition, this invention also relates to a device and a method of producing a foam molded part, whereby this method includes the following process steps:

introducing an initial quantity of a liquid foamable polymer material into the female mold die (13);

moving the intermediate cover (16) from its first position to its second position;

introducing an additional quantity of a foamable material;

expanding and polymerizing the material in the closed mold cavity;

opening the mold cavity;

moving the intermediate cover (16) into the removal position, thus unmolding the foam molded part (1) from the mold cavity;

removing (25) the polymerized foam molded part (1) from the intermediate cover (16).

This invention relates to a foam molded part, in particular for an upholstery element in an automotive seat according to the preamble of patent claim 1 as well as a device according to patent claim 5. In addition, this invention also relates to a method of producing the foam molded part according to patent claim 18.

Foam molded parts for upholstery elements for seats or chairs, in particular automotive seats, are usually produced by foaming liquid foamable polymer materials, such as soft polyurethane foam, in a foam mold which essentially already has the shape and contour of the future upholstery element. After foaming and polymerization in a mold cavity of the foam mold and after unmolding the foam molded part, the foam molded part can be provided with a textile upholstery covering, for example, optionally with other upholstery materials in between, to thus obtain an upholstery element for a seat or a chair.

In addition to the requirement that the foam molded parts for upholstery elements for automotive seats must be ready to receive the upholstery cover without requiring anything but minimal working after unmolding, such foam molded parts must meet an increasing number of additional requirements. In particular, the requirement for a further improvement in seat comfort might be mentioned, but this is often associated with a simultaneous reduction in the available structural space and a simultaneous increase in lightweight construction requirements based on the standard specifications.

The seat comfort of an upholstery element for an automotive seat is influenced essentially by the choice and design of the materials for the foam molded part. In addition to the elastic behavior and the damping properties, the air permeability of the materials used for the foam molded parts of the upholstery elements also plays an important role in the ergonomic design of an automotive seat, as do the air and water vapor transport properties ultimately achieved with the foam molded parts of the automotive seat covered with a textile or even leather.

In addition, different zones or areas of the upholstery elements of an automotive seat must fulfill specific different functions. For example, the zones of direct contact between the passenger and the vehicle seat must meet especially high requirements with regard to flexibility and damping properties as well as air and water vapor transport capability in the interests of improving seat comfort, whereas the lateral areas of the seat surface and the backrest of an automotive seat must primarily meet the requirement of providing an especially rigid and tight upholstery in the sense of lateral guidance in turning a corner.

To meet these requirements, in particular to be able to impart locally different elasticity and damping properties as well as improved air and water vapor transport capacity to an upholstery element for an automotive seat, upholstery elements for automotive seats have become known which comprise several different foam molded parts to be produced separately from materials having different mechanical properties or different properties that affect the microclimate.

To further improve the microclimate effect and the transport of moisture, which is required because of the perspiration secreted by human skin, in the area of the contact surfaces between the vehicle passengers and the automotive seat, it is also known that upholstery materials having an increased air permeability can be used in the area of these contact surfaces. With the same goal, multilayer upholstery structures capable of transporting air, perforations in the foam molded parts of the upholstery elements or actively elastically ventable upholstery elements have already been used for this purpose.

However, these known solutions all entail complicated work procedures in manufacturing the upholstery elements, in particular upholstery elements having multiple zones of different cushioning hardness or different air permeability, because these upholstery elements must be produced from multiple foam molded parts that are manufactured separately and/or with the additional use of special upholstery materials or inlays.

This can lead to the result that the comfort and climate control requirements of the automotive seat can no longer be met by the design engineer while at the same time maintaining the given cost goals. On the other hand, the known one-piece foam molded parts for upholstery elements which are perforated in the foaming operation or by means of subsequent operations and can be manufactured relatively inexpensively do not adequately meet the standard of improved climate control and in particular do not adequately meet the requirement of multiple upholstery zones of different hardness or elasticity.

Against the background of this state of the art, the object of the present invention is to create a foam molded part for an upholstery element of an automotive seat the manufacture of which requires only a few operations, so that this foam molded part can be manufactured inexpensively. On the other hand, however, this invention should make it possible to provide zones having different upholstery properties, in particular different elasticity properties, in the upholstery element and also to achieve an improved climate control and improved moisture transport in the area of the contact surfaces between the vehicle passengers and the automotive seat.

This object is achieved by a foam molded part according to the teaching of patent claim 1.

Furthermore, other objects of the present invention include providing a method of producing the foam molded part as well as creating a device for carrying out this method.

These objects are achieved by a device according to the teaching of patent claim 5 and by a method according to the teaching of patent claim 18.

Advantageous embodiments of this invention are the object of the subordinate claims.

The foam molded part according to this invention consists essentially of soft foamy material in an essentially known manner which can be produced by expansion and polymerization of a liquid foamable polymer material in a foam mold.

To produce an upholstery element for an automotive seat having zones of different mechanical properties and/or properties that affect the microclimate, especially with zones of different elasticity, flexibility or air and water vapor permeability, the foam molded part according to this invention comprises at least two spatially separate zones in which the soft foam-like material has different material properties, such as each having a different modulus of elasticity or different air or water permeability values. The minimum of two zones in which the soft foam-like material has different properties are designed in one piece, however, with the bordering planes of the zones having different material properties running at least partially essentially parallel to the seat surface of the upholstery element; in other words, the upholstery element, e.g., for the seat surface of an automotive seat, will have at least two layers of material arranged vertically one above the other in at least some areas. The one-piece design of the zones having different material properties according to this invention leads to inexpensive producibility of such a foam molded part having a multilayered structure for the upholstery element of an automotive seat.

Seat comfort and microclimate in the area of the contact surfaces between the passengers in the vehicle and the seat surface can already be improved to advantage by using a one-piece foam molded part designed according to this invention such that it may have spatially separate zones, each with different material properties of the soft foam material, with the zones having different material properties being arranged in particular one layer above the other vertically but also optionally being arranged side-by-side horizontally. In particular, specifically such soft foam material that is designed especially to meet the requirements with regard to flexibility, elasticity, damping properties and air and water vapor permeability can be used for those areas of the foam molded part which represent the future contact surfaces between the passengers of the vehicle and the automotive seat in an upholstery element of an automotive seat.

According to a preferred embodiment, the foam molded part according to this invention has at least one recess but preferably a plurality of recesses in the area of the contact surfaces between the passenger and the vehicle seat. These recesses extend like holes which start from the surface of the foam molded part that will later form the seat surface of the upholstery element and run essentially perpendicular to the seat surface of the upholstery element into the interior of the foam molded part. A further improvement in microclimate and ventilation in the area of the contact surfaces between the passenger and the automotive seat can be achieved with these hole-like recesses.

In addition, the desired flexibility or elasticity, especially at the surface of the foam molded part, can also be further varied in a controlled manner through the construction as determined by the selected number, cross-sectional size and shape, depth and area distribution of these hole-like recesses in the foam molded part. For example, it is thus also possible to manufacture an upholstery element for an automotive seat having areas of different flexibility, by using one foam molded part even with an essentially uniform material composition in an especially inexpensive manner.

For the production of such a foam molded part, for example, a foam material that is uniform and is relatively rigid in the polymerized state is used which optimally meets the requirements for lateral seat areas with regard to tightness and elasticity—in the sense of the lateral hold when turning a corner. The areas intended for direct contact between the passengers of the vehicle and the automotive seat can then be provided with a greater elasticity and flexibility in comparison with the rigid lateral seat areas, these properties being adjustable through the design, by providing these areas with the arrangement of hole-like recesses running essentially perpendicular to the surface of the upholstery element.

In this way, it is possible to obtain foam molded parts for upholstery elements which on the one hand basically meet the requirement of different elasticity properties in some zones or areas, but whereby on the other hand the ventilation of these contact surfaces is already improved to a certain extent due to the hole-like recesses in the foam molded part arranged in the area of the contact surface between the passengers in the vehicle and the automotive seat.

According to another embodiment of this invention, however, the foam molded part has at least one additional recess, but preferably multiple additional recesses, in addition to the hole-like recesses arranged perpendicular to the seat surface in the foam molded part, said additional recesses running like channels in the foam molded part essentially parallel to the seat surface of the upholstery element. These channel-like recesses running at a certain depth beneath the seat surface of the upholstery element in the foam molded part can by themselves also improve the elasticity properties as well as, when taken together with the air and water vapor permeability inherent in the foam material used, also improving the microclimate in the area of the contact surface between the passengers of the vehicle and the automotive seat.

According to another preferred embodiment of this invention, the channel-like recesses running at a certain depth beneath the seat surface of the upholstery element in the foam molded part are, however, arranged so that they each have an open connection with the hole-like recesses running essentially perpendicular to the seat surface of the upholstery element, thus permitting an exchange of the air contained in the hole-like recesses running perpendicular to the seat surface with the air contained in the channel-like recesses running parallel to the seat surface.

The combination of channel-like recesses running essentially parallel to the seat surface of the upholstery element with hole-like recesses running essentially perpendicular to the seat surface of the upholstery element, each communicating with the channel-like recesses in an open through-connection, leads to the solution according to this invention in the form of greatly improved air and moisture transport in the area of the contact surfaces between the passengers of the vehicle and the seat surface inasmuch as in particular the channel-like recesses running essentially parallel to the seat surface of the upholstery element in the foam molded part of the upholstery element are alternately compressed and expand again due to vibrations occurring during movement of the vehicle as well as shifting of the weight of the passengers of the vehicle on the vehicle seat. Due to this alternating compression and expansion of the channel-like recesses arranged in the foam molded part, there is an oscillating or pumping effect which ensures improved moisture transport according to this invention and improved ventilation of the contact surfaces between the passengers of the vehicle and the vehicle seat according to this invention.

The foam molded part described here can be produced in one piece in an especially advantageous as well as inexpensive manner by using a device which is also disclosed according to this invention, such that the foam molded part already has the zones with different material properties as soon as it is unmolded from the mold cavity of the foaming device in one piece as well as having both the channel-like recesses running essentially parallel to the seat surface and the hole-like recesses running essentially perpendicular to the seat surface.

In comparison with the manufacture of the known multi-zone foam upholstery elements which consist in general of several foam molded parts which are manufactured separately, each having different material properties, or in comparison with such foam molded parts which must be provided subsequently with functional layers, passages or perforations, production of the foam molded part described here by means of the device according to this invention permits a significant reduction in the number of manufacturing steps, and it is thus possible to produce foam molded parts having the desired ventilation and comfort properties while at the same time greatly reducing the manufacturing costs.

The device according to this invention, which can be used in particular for production of the foam molded part described above, has at least the following elements:

a bottom mold element or a female mold die,

an upper mold element or a mold cover, whereby the female mold die and the mold cover together, when closed, form a mold cavity having the shape of the foam molded part to be manufactured,

as well as at least one movable intermediate cover, preferably with a profiled cross section, whereby this intermediate cover may be moved from a first position into a second position, in which second position the intermediate cover assumes a spatially fixed position within the closed mold cavity.

The intermediate cover which assumes a spatially fixed position within the mold cavity in its second position serves on the one hand to subdivide the closed mold cavity into different spatial areas which are largely closed off with respect to one another, and on the other hand, due to its profiling in cross section in the manner of a mold core, it also serves to produce functional recesses in the foam molded part of the upholstery element directly in the foaming operation; development and function of these recesses are described in greater detail below.

According to an especially preferred embodiment of this invention, the intermediate cover of the device is designed to be essentially flat at first. The intermediate cover designed in this way then divides the closed mold cavity into two separate spatial areas in its second position. Preferably, however, the intermediate cover is smaller in its cross-sectional area than the cross-sectional area of the mold cavity in the plane assumed by the intermediate cover in its second position, so that the intermediate cover cannot completely close off the two spatial areas from one another.

This achieves the result that the two spatial areas of the mold cavity separated by the intermediate cover are connected to one another at least on one side but preferably on several sides of the closed mold cavity, extending around the intermediate cover. Preferably the locations where the two spatial areas of the mold cavity reaching around the intermediate cover are connected to one another together form an essentially U-shaped design.

The two spatial areas that are separated from one another by the intermediate cover in its second position but are still connected to one another in a U-shaped edge area can then each be filled separately with liquid foamable polymer material which may have different material properties in each of the two spatial areas. The occurrence of unwanted mixing of the different liquid foamable polymer materials when filling the mold or during expansion is reduced or prevented by the intermediate cover.

The spatial areas of the mold cavity of the foaming device, which are essentially separated from one another according to this invention by the intermediate cover but are still connected to one another along a U-shaped edge, make it possible for a foam molded part having multiple areas or zones of different mechanical or different properties that affect the microclimate of the foam material to be produced in the device according to this invention, but these areas or zones having different material properties are joined together in one piece.

According to another preferred embodiment of this invention, the intermediate cover may also have elevated edges or chamfered edges on at least one of its side edges, but preferably on several side edges. These elevated edges or chamfered edges of the intermediate cover make it possible to prevent a second quantity of liquid foamable polymer material which is introduced into the spatial area of the mold cavity located above the intermediate cover from flowing to an unwanted extent beyond the exposed edges of the intermediate cover into the spatial area of the mold cavity beneath the intermediate cover before or during expansion and polymerization, becoming combined there with a first quantity of a liquid foamable polymer material in an unwanted manner.

To prevent unwanted displacement or shifting of the zone of the foam molded part formed by the spatial area of the mold cavity above the intermediate cover in subsequent use of the foam molded part according to this invention in an upholstery element of an automotive seat in comparison with the zone of the foam molded part formed by the spatial area of the mold cavity beneath the intermediate cover, it is advantageous according to another embodiment of this invention if the intermediate cover has at least one crease but preferably several creases.

The creases in the intermediate cover may be designed to be half-round, polygonal or V-shaped, for example, although this list is by no means exclusive, and they run essentially parallel to a direction of unmolding of the foam molded part from the intermediate cover. Depending on the shape and orientation, the creases in the spatial area of the foam molded part located beneath the plane of the intermediate cover produce V-shaped elevations, for example, and at the same time they produce V-shaped indentations, for example, in the spatial area of the foam molded part located above the intermediate cover, said V-shaped elevations and recesses coming to lie in or on top of one another in a complementary shape after unmolding the foam molded part and after removal of the foam molded part from the intermediate cover in the removal position. Due to the form-fitting connection achieved in this way by means of complementary intermeshing V-shaped creases and V-shaped recesses achieved between the areas of the foam molded part located above the plane of separation of the intermediate cover and the areas of the foam molded part located beneath the plane of separation of the intermediate cover, horizontal displacement or slippage of these areas of the foam molded part with respect to one another is prevented in an advantageous manner.

According to an especially preferred embodiment of this invention, this device for producing the foam molded part described above is characterized by the fact that the bottom mold element or the female mold die has elevated projections which may be in the shape of an essentially cylindrical, prismatic, conical or truncated conical, pyramid-shaped or truncated pyramid-shaped design and are arranged essentially perpendicular or upright in the female mold die. The projections arranged in this way in the female mold die produce the hole-like recesses arranged essentially perpendicular to the seat surface of the future upholstery element according to their arrangement, size and distribution in the female mold die in the foaming operation.

To guarantee a defined position and a fixed support of the intermediate cover in the mold cavity in its second position, it is advantageous according to a preferred embodiment of this invention if the intermediate cover can be brought to rest on at least one of the projections of the bottom mold element or female mold die in its second position.

To produce functional recesses in the foam molded part of the upholstery element, for example, it is advantageous according to another embodiment of this invention if the intermediate cover has at least one elevation. Then preferably the cross-sectional area of the elevation of the intermediate cover decreases slightly and essentially uniformly along the direction of unmolding of the foam molded part from the intermediate cover in the manner of a mold bevel or inclination to permit easy unmolding and removal of the polymerized foam molded part from the intermediate cover.

For example, an additional functional element or component such as, but by no means exclusively limited to, a sensor element or a heating element, a channel-like component, e.g., for passing heated air through the foam molded part of the automotive seat or a housing element for an adjustment drive of the automotive seat may be arranged in such a recess formed by an elevation in the intermediate cover in the manner of a mold core in the foam molded part after the foam molded part has been unmolded.

To produce the channel-like recesses in the foam molded part of the upholstery element running essentially parallel to the seat surface of the upholstery element according to this invention, it is advantageous according to another embodiment of this invention if the intermediate cover has at least one but preferably multiple elongated elevations having an essentially half-round, polygonal or V-shaped cross section, preferably running essentially parallel to the direction of unmolding of the foam molded part from the intermediate cover.

Due to the combination of elevated projections arranged in the bottom mold element or the female mold die and the elongated elevations arranged on the intermediate cover, it is possible to produce both channel-like recesses running essentially parallel to the surface of the seat of the upholstery element as well as hole-like recesses running essentially perpendicular to the seat surface to advantage in just one operation in foaming the foam material according to this invention.

The through-connection between the hole-like recesses running essentially perpendicular to the seat surface of the upholstery element and the channel-like recesses running essentially parallel to the seat surface of the upholstery element, said connection being necessary for the pumping and aerating effect of the foam molded part according to this invention, can be achieved by the fact that according to another embodiment of this invention, at least one elevation but preferably several or all of the elevations on the intermediate cover can be brought into contact with at least one projection but preferably several or all of the projections of the bottom mold element or female mold die in the second position of the intermediate cover.

According to another embodiment of this invention, the foaming device is characterized in that the intermediate cover can be moved between its first position and its second position or the removal position essentially in the manner of a hinge.

It is especially advantageous here if the upper mold element or the mold cover, the intermediate cover itself as well as the bottom mold element or female mold die are joined together by means of a common axle so that the upper mold element, the intermediate cover as well as the bottom mold element can each be moved about this common axle so that they are folded toward one another in the manner of a hinge.

In order to facilitate removal of the foam molded part from the intermediate cover after opening the mold cover and after unmolding the foam molded part from the female mold die, which is accomplished by pivoting the intermediate cover from its second position into its first position or the removal position, it is advantageous according to another embodiment of this invention if the intermediate cover is designed in the manner of a mold bevel or inclination along the unmolding direction of the foam molded part, and thus there is a slight and essentially uniform decrease in the cross-sectional area of the intermediate cover as well as the cross-sectional areas of any creases and/or elevations that are optionally present on the intermediate cover along the direction of unmolding of the foam molded part.

The method according to this invention, which is used to manufacture a foam molded part of the type described above using the device described above, includes the following process steps:

in a first process step, first a certain initial quantity or a certain initial volume of a liquid foamable polymer material is introduced into the female mold die or the mold cavity by means of a device for metered addition;

then the intermediate cover is moved from its first position, in which the intermediate cover allows the introduction of a first quantity of liquid foamable polymer material into the female mold die by means of the device for metered addition, into the second position, where the intermediate cover assumes a fixed position in space in the mold cavity;

in the next process step, an additional quantity or an additional volume of a liquid foamable polymer material is introduced into the female mold die or the mold cavity or onto the intermediate cover in its second position, where the additional quantity of liquid foamable polymer material has a different composition or can lead to different material properties of the soft foam material produced from it in comparison with the initial quantity of liquid foamable polymer material;

in another process step, the liquid foamable polymer material is expanded and polymerized in the previously closed mold cavity, thus forming a molded part of foamed soft foam material in the mold cavity;

after polymerization of the soft foam material in the closed mold cavity, the mold cavity is opened in another process step, with an upper mold element being moved away, for example, or the mold cover being opened;

then in another process step, the intermediate cover is moved from its second position back into its first position or into a removal position in which the intermediate cover is essentially freely accessible on at least one side, and the polymerized foam molded part can be unmolded at the same time from the bottom mold element or from the female mold die through this movement of the intermediate cover from its second position into the removal position; and

in another process step, the polymerized foam molded part is removed from the intermediate cover which is in the removal position.

According to another embodiment of this invention, the method of producing the foam molded part described above by using the device described above is characterized in that before expansion and polymerization of the liquid foamable polymer material inside the mold cavity of the foam mold, additional functional elements or components can be arranged on the intermediate cover.

The additional functional elements which are mounted or otherwise placed on the intermediate cover in this way are essentially completely permeated or surrounded by liquid foamable polymer material in expansion of the liquid foamable polymer material in the mold cavity, and in this way they are essentially fixedly incorporated into the foam molded part in the subsequent polymerization of the liquid foamable polymer material.

The elements which can be incorporated into the foam molded part in this way include, for example, but by no means exclusively, reinforcing elements for the foam molded part, especially air-permeable spacer mats or nonwovens, air-impermeable barrier films, anchoring elements for securing preferably upholstery coverings on the foam molded part, seat occupancy sensors or seat heating elements.

According to another embodiment of this invention, the method of producing the foam molded part described above using the device described above is characterized in that after removing the polymerized foam molded part from the intermediate cover, at least one additional element or component can be arranged in at least one recess formed by an elevation on the intermediate cover in the manner of a mold core in the foam molded part such that the additional element remains in the foam molded part. For example but by no means exclusively, this may include reinforcing elements, spacer mats, barrier films, elements for anchoring upholstery covers on the foam molded part, sensor elements or heating elements, channel-like components, e.g., for conducting fan air through the foam molded part of the automotive seat or housing elements, e.g., for adjustment drives for the automotive seat.

This invention is explained in greater detail below on the basis of the following drawings illustrating just one embodiment. They show:

FIG. 1 a schematic diagram (not drawn to scale) of a foam molded part according to this invention having hole-like recesses running perpendicular to the surface of the seat;

FIG. 2 a cross section of the foam molded part according to FIG. 1 in a diagram corresponding to that in FIG. 1;

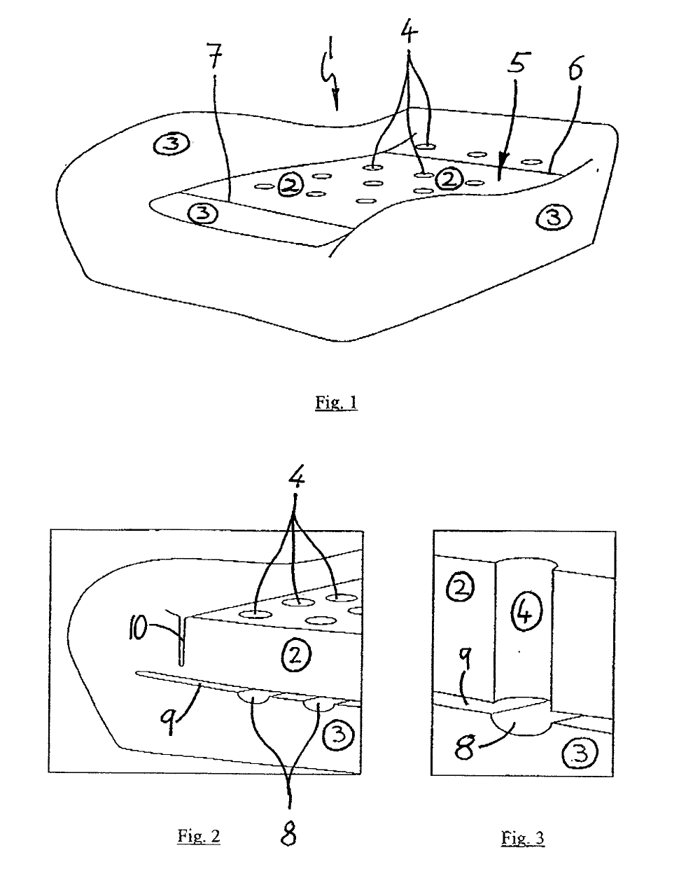

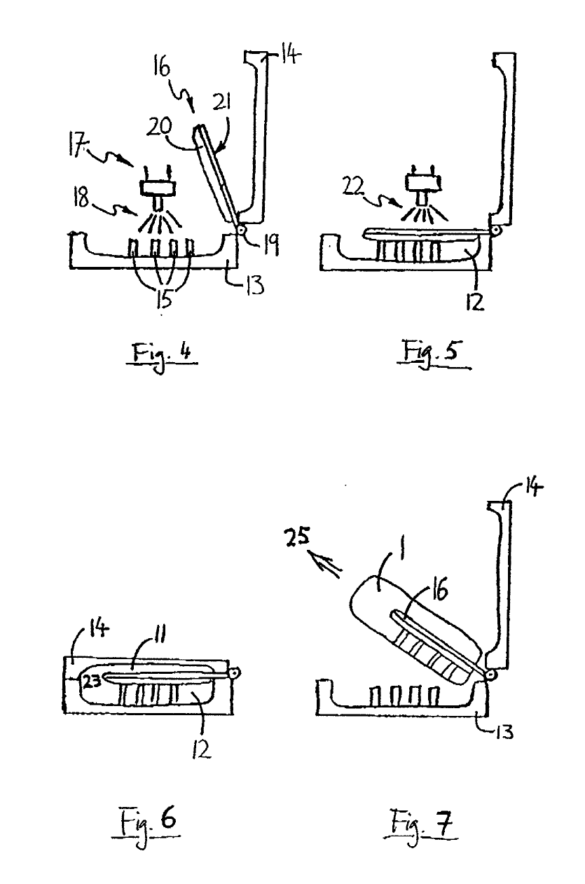

FIG. 3 a section through one of the hole-like recesses and through one of the channel-like recesses in a foam molded part according to this invention, shown on an enlarged scale corresponding to that of the preceding figures;

FIG. 4 a schematic diagram of a device or a foam mold according to this invention, shown with the mold cover open and also with the intermediate cover open during the addition of a first quantity of liquid foamable polymer material;

FIG. 5 a diagram corresponding to that shown in FIG. 4 of a device with the intermediate cover closed while adding a second quantity of liquid foamable polymer material;

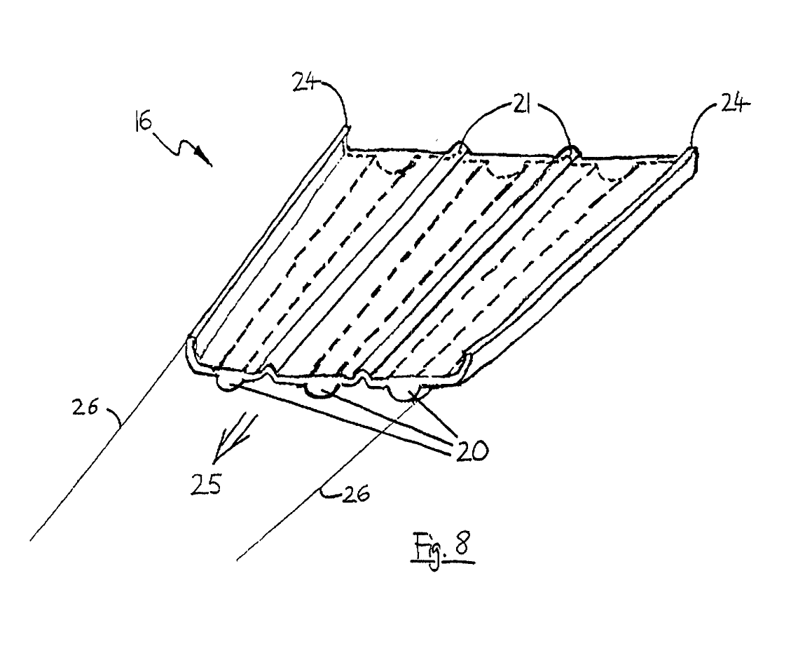

FIG. 6 the closed device in a diagram which also corresponds to that in FIG. 4;

FIG. 7 the device after polymerization of the foam molded part, in a diagram corresponding to the preceding figures, showing the mold cover opened again and the intermediate cover and the foam molded part in the removal position, and

FIG. 8 an intermediate cover according to this invention for the device, shown here in a schematic perspective view, with V-shaped creases, elongated semi-cylindrical elevations and edges canted upward.

FIG. 1 shows the foam molded part 1 according to this invention, comprising one-piece areas 2, 3 having different mechanical properties or different material properties that influence the microclimate, after removal from the mold cavity of the foam mold. The foam molded part 1 has the hole-like recesses 4 according to this invention which extend from the surface of the foam molded part 1 which forms the seat surface 5 to a certain depth of the foam molded part 1 in the manner of a blind hole. Furthermore, the course of the border between areas 2 and 3 where the soft foam material has different mechanical or properties affecting the microclimate is indicated by lines 6, 7.

FIG. 2 shows an area of the foam molded part 1 according to this invention in a sectional diagram, showing both the hole-like recesses 4 as well as the channel-like recesses 8 which together serve to improve the ventilation and the moisture transport in the area of the contact surfaces between the passengers of the vehicle and the automotive seat. Furthermore, FIG. 2 shows the recess or the dividing plane 9 formed by the intermediate cover 16 between the spatial area 2 of the foam molded part 1 located beneath the intermediate cover 16 during the molding operation and the spatial area 3 of the foam molded part 1 which was located above the intermediate cover 16 during the molding operation. In the embodiment shown here, the recess 10 illustrated in FIG. 2 was produced by a blade-like elevation which is complementary in shape to recess 10 and is arranged on the bottom of the mold cavity, serving in particular to form a border to prevent unwanted mixing of the quantities 18, 22 of liquid foamable polymer material introduced into areas 11 and 12 (FIG. 6).

FIG. 3 shows on an enlarged scale a section through one hole-like recess 4 in a foam molded part 1 according to this invention. This shows how the hole-like recesses 4 communicate with the channel-like recesses 8 in the foam molded part 1 according to this invention in such a way that an exchange of air is possible between air in hole-like recesses 4 and air in channel-like recesses 8. Furthermore, FIG. 3 also shows the recess or dividing plane 9 formed by the intermediate cover 16 between areas 2 and 3 of the foam molded part 1.

The device for production of the foam molded part 1 according to this invention, shown only schematically in the figures, has according to FIG. 4 a female mold die 13 and a mold cover 14 which together form a mold cavity for a foam molded part 1 when closed. Female mold die 13 is provided with cylindrical projections 15 which form corresponding cavities or hole-like recesses 4 in the foam molded part 1 in the subsequent foaming of the soft foamy material.

In addition, the device according to this invention has an intermediate cover 16 which forms two spatially separate areas 11 and 12 in the mold cavity when the foam mold is closed according to FIG. 6. Area 12 of the mold cavity forms area 2 of molded part 1 of a seat upholstery which will later face the surface of the seat or the backrest of an automotive seat, while area 11 of the mold cavity forms area 3 of a foam molded part 1 which will later face the frame of the seat or backrest of an automotive seat.

According to FIG. 4, with mold cover 14 opened, a defined initial quantity of liquid foamable polymer material 18 is introduced into female mold die 13 with the mold in the opened state by means of a metering and/or mixing device having a metering head 17. To do so, the material which is used after polymerization has the elasticity and air transport properties desired in particular for contact areas between passengers of a vehicle and the automotive seat.

After retraction of metering head 17, the intermediate cover 16 is folded down or closed by moving it about an axle 19 which connects the female mold die 13, the intermediate cover 16 and the mold cover 14 together in the manner of a hinge.

The intermediate cover 16 is provided with elongated elevations 20 that point downward and have a half-round cross section, for example, forming cavities which correspond in shape or channel-like recesses 8 in the foam molded part 1 (FIGS. 7 and 8). The elevations 20 on the intermediate cover 16 are shown in a side view in FIGS. 4 through 7, and when the intermediate cover is folded down, they come to rest on the end faces of the projections 15 in the female mold die 13.

In addition, the intermediate cover 16 according to FIG. 8 has creases 21 which produce V-shaped elevations, for example, in the area 2 of the foam molded part 1 which comes to lie beneath the intermediate cover 16 during the foaming operation, and at the same time they produce V-shaped recesses in area 3 of foam molded part 1 located above the intermediate cover 16 during the foaming operation. The V-shaped elevations come to rest in a complementary manner against the V-shaped indentations after foam molded part 1 is unmolded from the mold, thus ensuring a form-fitting connection between the top and bottom layers 2, 3 of the foam molded part 1, thereby stabilizing the seat upholstery of the automotive seat.

After folding down the intermediate cover 16, the metering head 17 is advanced again, and a second quantity of liquid foamable polymer material 22 is fed into area 11 above the intermediate cover 16 (FIG. 5). In this case, a material is used which, after polymerization, has the rigid upholstery properties required in particular for areas 3 of the seat upholstery of an automotive seat on the side and/or on the frame.

The cross-sectional area of the intermediate cover 16 according to FIG. 6 is smaller than the cross-sectional area of the mold cavity in the plane of the intermediate cover 16 which has been folded down so that the intermediate cover 16 does not completely seal off the upper area 11 from the bottom area 12 of the mold cavity, and instead the two spatial areas 11 and 12 which are separated from one another by the intermediate cover 16 communicate with one another along a U-shaped area 23 enclosed by the intermediate cover 16 and the edge of the mold cavity.

However, an unwanted amount of overflow of the second quantity of liquid foamable polymer material 22 over the intermediate cover 16 through the U-shaped exposed area 23 into area 12 beneath the intermediate cover 16, causing the first quantity of liquid foamable polymer material 18 to become mixed with it, is prevented by elevated edges or chamfered edges 24 directed upward (FIG. 8) on the intermediate cover 16.

After introducing the second quantity of liquid foamable polymer material 22 into the area 11 above the intermediate cover 16, the mold cover 14 is closed (FIG. 6). The initial quantity of the liquid foamable polymer material 18 then expands and polymerizes in the area 12 beneath the intermediate cover 16, the second quantity of liquid foamable polymer material 22 expands and polymerizes in the area 11 above the intermediate cover 16, forming a one-piece foam molded part 1 because of the spatial connection 23 between areas 11 and 12.

If all the material in the mold cavity has been polymerized, then according to FIG. 7, the mold cover 14 is opened, thus unmolding a first partial area of the polymerized foam molded part 1 located at the top in the mold cavity. A second partial area of the polymerized foam molded part 1, however, is still located at 12 in the female mold die 13. Then, however, by pivoting the intermediate cover 16 which is then in the interior of the foam molded part 1 back into its starting position or into a removal position the foam molded part 1 is also unmolded from female mold die 13 without requiring any additional effort.

The finished foam molded part 1 can then be removed from the intermediate cover 16, which is in the removal position, by a simple means, preferably by a fully mechanized operation. To facilitate the removal operation, the intermediate cover 16 including creases 21 and/or elevations 20, has a mold inclination 26 in the direction 25 of unmolding (FIG. 8).

1. A foam molded part, in particular for an upholstery element of an automotive seat, consisting essentially of a soft foam-like material, characterized by at least two spatially separate zones 2, 3 which are designed in one piece, each having different properties of the soft foam-like material, whereby the bordering planes of zones 2, 3 having different material properties run essentially parallel to the seat surface (5) of the upholstery element at least to some extent.

2. A foam molded part according to claim 1, characterized by at least one hole-like recess (4) starting from a surface of the a foam molded part (1) facing the seat surface (5) of the upholstery element and running essentially perpendicular to the seat surface (5) of the upholstery element.

3. A foam molded part according to claim 1 or 2, characterized by at least one channel-like recess (8) running essentially parallel to the seat surface (5) of the upholstery element, arranged within the foam molded part (1).

4. A foam molded part according to one of claims 1 through 3, characterized in that at least one hole-like recess (4) starting from a surface of the foam molded part (1) has an air-permeable connection between at least one channel-like recess (8) in the foam molded part (1) and the surface of the foam molded part (1) facing the seat surface (5) of the upholstery element.

5. A device for producing a foam molded part, in particular for an upholstery element of an automotive seat, having:
a bottom mold element (13),
an upper mold element (14), with the upper mold element (14) and the bottom mold element (13) forming a mold cavity when closed,
at least one movable intermediate cover (16) having a preferably profiled cross section, whereby the intermediate cover (16) can be moved from a first position into a second position in which the intermediate cover (16) assumes a spatially fixed position within the closed mold cavity.

6. A device according to claim 5, characterized in that the intermediate cover (16) is designed to be essentially flat, and the mold cavity in the second position of the intermediate cover (16) is subdivided by the intermediate cover (16) into a plurality of spatial areas (11, 12), preferably two such areas, such that the two spatial areas (11, 12) still communicate with one another on at least one side, preferably on several sides of the mold cavity.

7. A device according to claim 5 or 6, characterized in that the locations where the spatial areas (11, 12) of the mold cavity communicate with one another together form an essentially U-shaped design (23).

8. A device according to one of claims 5 through 7, characterized in that the intermediate cover (16) has elevated edges or chamfered edges (24) on at least one side edge but preferably on several side edges.

9. A device according to one of claims 5 through 8, characterized in that the intermediate cover (16) has at least one but preferably several in particular half-round or V-shaped creases (21), whereby the creases (21) run preferably essentially parallel to the direction (25) of unmolding of the foam molded part (1) from the intermediate cover (16).

10. A device according to one of claims 5 through 9, characterized in that the bottom mold element (13) has projections (15) which have a preferably essentially cylindrical, prismatic, conical, truncated conical, pyramid-shaped or truncated pyramid-shaped design and are arranged essentially perpendicular in the bottom mold element (13).

11. A device according to one of claims 5 through 10, characterized in that the intermediate cover (16) in its second position can be brought into contact with at least one projection (15) on the bottom mold element (13).

12. A device according to one of claims 5 through 11, characterized in that the intermediate cover (16) has at least one elevation (20), whereby preferably the cross-sectional area of the elevation (20) decreases slightly and essentially uniformly in the manner of a mold inclination along the direction (25) of unmolding of the foam molded part (1) from the intermediate cover (16).

13. A device according to one of claims 5 through 12, characterized in that the intermediate cover (16) has at least one but preferably several essentially elongated elevations (20) having an essentially half-round, polygonal or V-shaped cross section, whereby these elevations (20) run essentially parallel to the direction (25) of unmolding of the foam molded part (1) from the intermediate cover (16).

14. A device according to one of claims 5 through 13, characterized in that at least one elevation (20) of the intermediate cover (16) can be brought into contact with at least one but preferably several of the projections (15) of the bottom mold element (13) at the same time in the second position of the intermediate cover (16).

15. A device according to one of claims 5 through 14, characterized in that the intermediate cover (16) can be moved essentially in the manner of a hinge between its first position and its second position or the removal position.

16. A device according to one of claims 5 through 15, characterized in that the top mold element (14), the intermediate cover (16) and the bottom mold element (13) can be joined together so they can move in the manner of a hinge about a common axle (19).

17. A device according to one of claims 5 through 16, characterized in that the cross-sectional area of the intermediate cover (16) and the cross-sectional areas of any creases (21) and/or elevations (20) that are optionally present on the intermediate cover (16) each decrease slightly and essentially uniformly in the manner of a mold inclination (26) along the direction (25) of unmolding of the foam molded part (1) from the intermediate cover (16).

18. A method of producing a foam molded part in particular for an upholstery element of an automotive seat using the device according to one of claims 5 through 17 and having the following process steps:
introducing an initial quantity (18) of a liquid foamable polymer material into the bottom mold element (13) or into the mold cavity;
moving the intermediate cover (16) out of the first position which allows the initial quantity (18) of the liquid foamable polymer material to be introduced into the bottom mold element (13) into the second position;
introducing an additional quantity (22) of a liquid foamable polymer material into the mold cavity or into the bottom mold element (13);
causing the liquid foamable polymer material (18, 22) to expand and polymerize in the previously closed mold cavity;
opening the mold cavity;
moving the intermediate cover (16) from its second position into its first position or into a removal position where the intermediate cover (16) is essentially freely accessible on at
least one side, thereby unmolding the polymerized foam molded part (1) from the mold cavity; and
removing the polymerized foam molded part (1) from the intermediate cover (16).

19. A method according to claim 18, characterized in that at least one additional element or component can be arranged on the intermediate cover (16) before expanding and polymerizing the liquid foamable polymer material (18, 22) in the mold cavity of the foam mold such that the additional element remains incorporated in the foam molded part (1) after foaming and after unmolding the foam molded part (1) from the mold cavity; this may include in particular a reinforcing element, a spacer mat, a barrier film, an element for anchoring preferably upholstery coverings on the foam molded part (1), a sensor element or a heating element.

20. A method according to claim 18 or 19, characterized in that after removing the polymerized foam molded part (1) from the intermediate cover (16), at least one additional element or component can be arranged in at least one recess formed by an elevation (20) on the intermediate cover (16) in the manner of a mold core produced in the foam molded part (1) such that the additional element remains in the foam molded part (1) and may include in particular a reinforcing element, a spacer mat, a barrier film, an element for anchoring preferably upholstery coverings on the foam molded part (1), a sensor element or a heating element, a channel-like component or a housing element.
